(19) United States
(12) Patent Application Publication
(10) Pub. No.: US 2005/0253778 A1
(43) Pub. Date: Nov. 17, 2005

(54) Method and system for driving dual display panels

(76) Inventors: Yong-Guen Ku, Suwon-Si (KR); Hyo-Jin Ha, Suwon-Si (KR)

Correspondence Address: LAW OFFICE OF MONICA H CHOI, P O BOX 3424, DUBLIN, OH, 430160204, US

(21) Appl. No.: 11/098,725

(22) Filed: Apr. 4, 2005

(30) Foreign Application Priority Data
May 14, 2004 (KR) 2004-34271

(51) Int. Cl. G09G 5/00

(52) U.S. Cl. 345/1.3

(57) ABSTRACT

For driving dual display panels, one of first and second display panels is determined to be a display mode panel, and the other one of the display panels is determined to be a non-display mode panel. Image data is displayed on the display mode panel, and the image data is stored in a same shared memory for when the display mode panel is either one of the first and second display panels. In addition, the non-display mode panel is driven in a selected one of a black display mode or a white display mode every predetermined frame interval for reducing noise.

### BACKGROUND OF THE INVENTION

This application claims priority to Korean Patent Application No. 2004-34271, filed on May 14, 2004, in the Korean Intellectual Property Office, the disclosure of which is incorporated herein in its entirety by reference.

1. Field of the Invention

The present invention relates generally to displays, and more particularly, to a method and system for driving dual displays with minimized memory capacity and reduced noise.

2. Description of the Related Art

A flat panel display is light and thin, and consumes less current than a CRT (cathode ray tube) display. Additionally, since the flat panel display may be made small, flat panel displays are widely used in portable devices such as PDAs, portable communications terminals, and digital cameras as well as personal computers.

The flat panel display may be a liquid crystal display, a plasma display, or an organic EL (electroluminescence) display. A liquid crystal display is generally used in portable communications terminals due to its relatively low cost.

Currently, broadly used portable communications terminals are dual folder-type communications terminals in which a sub display is used as an external display and a main display is used as an internal display, or a slide-type in which an area of a display varies according to whether the portable communications terminal is in a standby mode or an active mode.

In the standby mode of the mobile communications terminal, a small quantity of data indicating the communications terminal state or time information is displayed. In the active mode, a large quantity of data such as communication information or multimedia information is displayed. Further, in the standby mode, data is displayed only on a sub display panel, and in the active mode, data is displayed only on a main display panel. In the slide type communications terminal, data is displayed on part of the display panel in the standby mode and data is displayed on the whole area of the display panel in the active mode.

A portable mobile communications terminal with dual display panels typically has a driver for driving a main display, a driver for driving a sub display, and separate memories for storing image data to be displayed on the main display panel and the sub display panel.

FIG. 1 is a block diagram of a conventional dual panel driving system 100 including two driving circuits. Referring to FIG. 1, the conventional dual panel driving system 100 includes a sub display panel 102, a main display panel 104, a sub display panel driving circuit 106, and a main display panel driving circuit 108.

The sub display panel driving circuit 106 includes a timing controller 112, a memory 114, a gate driving circuit 116, and a source driving circuit 118. Similarly, the main display panel driving circuit 108 includes a timing controller 122, a memory 124, a gate driving circuit 126, and a source driving circuit 128.

Such two driving circuits included in the display panels result in the portable communications terminal being thick. In particular, reducing the thickness of the communications terminals using color liquid crystal panels is desired since color liquid crystal panels are thicker than monochrome display panels.

Thus, a single display panel driving circuit has been developed for driving both the sub display panel and the main display panel. FIG. 2 is a block diagram of a conventional dual panel driving system 200 including a single driving circuit 206. Referring to FIG. 2, the dual panel driving system 200 includes a sub display panel 202, a main display panel 204, and the display panel driving circuit 206.

A screen size of the sub display panel 202 is smaller than that of the main display panel 204. As shown in FIG. 2, a timing controller 208 and memory 210 are included in the display panel driving circuit 206. The display panel driving circuit 206 drives first gate lines 212 connected to the sub display panel 202 and second gate lines 214 connected to the main display panel 204. Additionally, the display panel driving circuit 206 drives source lines 216 connected to both the sub display panel 202 and the main display panel 204.

In the dual panel driving system of FIG. 2, when the communications terminal is in a standby mode, the display panel driving circuit 206 turns off the main display panel 204 by turning off the second gate lines 214. Then, while a scanning signal is applied sequentially on the first gate lines 212, image data is applied on the source lines 216. Similarly, when the communications terminal is in an active mode, the display panel driving circuit 206 turns off the sub display panel 202 by inactivating the first gate lines 212. Then, while a scanning signal is applied sequentially on the second gate lines 214, image data is applied on the source lines 216.

According to the driving system of FIG. 2, since only one driving circuit is used to drive the two display panels 202 and 204, the driving system is easily designed and the display of the communications terminal may be thin.

FIG. 3 is a block diagram of memories used in the dual panel driving system of FIG. 2. Referring to FIG. 3, the sub display panel 202 has a display area of A×B, where A is the number of gate lines connected to the sub display panel and B is the number of source lines connected to the sub display panel. The main display panel 204 has a display area of C×D, where C is the number of gate lines connected to the main display panel and D is the number of source lines connected to the main display panel.

The image memory 210 includes a first memory 210_a for the sub display panel and a second memory 210_b for the main display panel. The size of the memories 210 corresponds to the size of the main display panel and the size of the sub display panel. Thus, the first memory 210_a for the sub display panel has a data capacity for A×B intersections of the gate lines and the source lines thereon. Similarly, the second memory 210_b for the main display panel has a data capacity for C×B intersections of the gate lines and the source lines thereon.

The first memory 210_a stores and outputs image data to be displayed on the sub display panel 202. The second memory 210_b stores and outputs image data to be displayed on the main display panel 204. However, in general, a portable communications terminal rarely drives a sub display panel and a main display panel simultaneously. That is, in general, the portable communications terminal drives only the sub display panel in the standby mode or drives only the main display panel in the active mode. Therefore, the two separate memories 210_a and 210_b for storing image data for the sub and main display panels result in unnecessary production cost and an undesired large size of the driving circuit 206.

### SUMMARY OF THE INVENTION

Accordingly, a single shared memory is used to store image data for driving dual display panels.

In a method and system for driving dual display panels according to an aspect of the present invention, one of first and second display panels is determined to be a display mode panel, and the other one of the display panels is determined to be a non-display mode panel. Image data is displayed on the display mode panel, and the image data is stored in a same shared memory for when the display mode panel is either one of the first and second display panels.

In another embodiment of the present invention, the shared memory has a capacity corresponding to a larger one of the first and second display panels.

In a further embodiment of the present invention, the non-display mode panel is driven in a selected one of a black display mode or a white display mode. In that case, gate lines of the non-display mode panel are driven with an activated voltage every predetermined frame interval for a display frame rate for the display mode panel. In addition, source lines of the non-display mode panel are driven with a respective predetermined voltage corresponding to the selected one of the black display mode or the white display mode when the gate lines of the non-display mode panel are driven with the activated voltage.

In another embodiment of the present invention, the display mode panel is set to the larger one of the first and second display panels.

In a further embodiment of the present invention, source lines of the non-display mode panel are extended from a subset of source lines of the display mode panel.

In a method and system for driving dual display panels according to another aspect of the present invention, one of first and second display panels is determined to be a display mode panel, and the other one of the display panels is determined to be a non-display mode panel. Image data is displayed on the display mode panel at a display frame rate, and the non-display mode panel is driven in a selected one of a black display mode or a white display mode every predetermined frame interval of the display frame rate.

In such an example embodiment, gate lines of the non-display mode panel are driven with an activated voltage for the every predetermined frame interval. In addition, source lines of the non-display mode panel are driven with a respective predetermined voltage corresponding to the selected one of the black display mode or the white display mode when the gate lines of the non-display mode panel are driven with the activated voltage.

In this manner, a single shared memory is used for storing image data for driving both panels for minimized memory capacity. In addition, by driving the non-display mode panel in one of the black or white display modes, noise is reduced.

### BRIEF DESCRIPTION OF THE DRAWINGS

The above and other features and advantages of the present invention will become more apparent when described in detailed exemplary embodiments thereof with reference to the attached drawings in which:

FIG. 1 shows a block diagram of a conventional dual panel driving system with two driving circuits;

FIG. 2 shows a block diagram of a conventional dual panel driving system with a single driving circuit;

FIG. 3 shows a block diagram illustrating sizes of memories for storing image data in the dual panel driving system of FIG. 2, according to the prior art;

FIG. 4 shows a block diagram of a display panel driving system with a single shared memory for driving dual panels, according to an embodiment of the present invention;

FIGS. 5A and 5B illustrate partial display operations according to an embodiment of the present invention;

FIG. 6 shows a timing diagram of a dual panel driving method according to an embodiment of the present invention;

FIG. 7 illustrates setting of gate lines for performing the dual panel driving method of FIG. 6, according to an embodiment of the present invention;

FIG. 8 illustrates a scanning of the gate lines for performing the dual panel driving method of FIG. 6, according to an embodiment of the present invention;

FIG. 9 shows a more detailed block diagram of the display panel driving system of FIG. 4, according to an embodiment of the present invention; and

FIG. 10 shows a flow-chart of steps during operation of the display panel driving system of FIG. 9, according to an embodiment of the present invention.

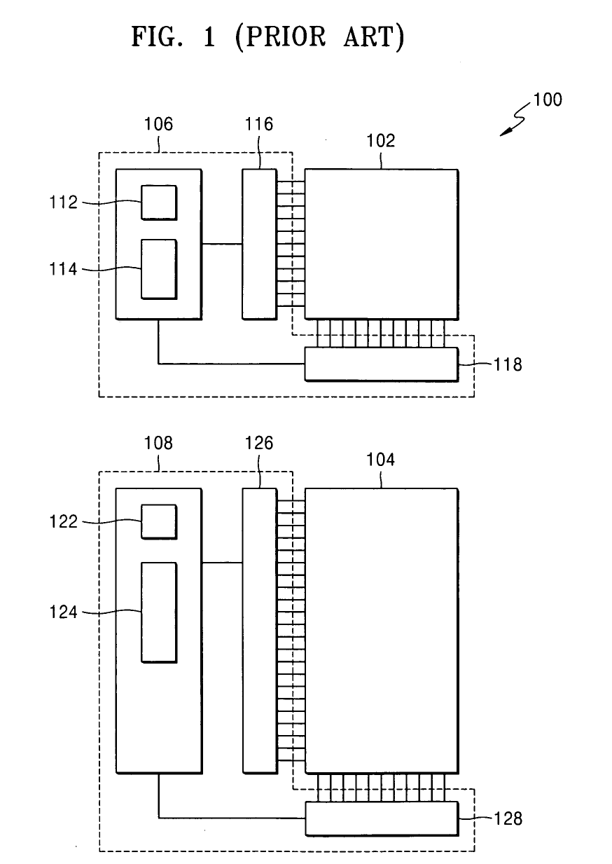

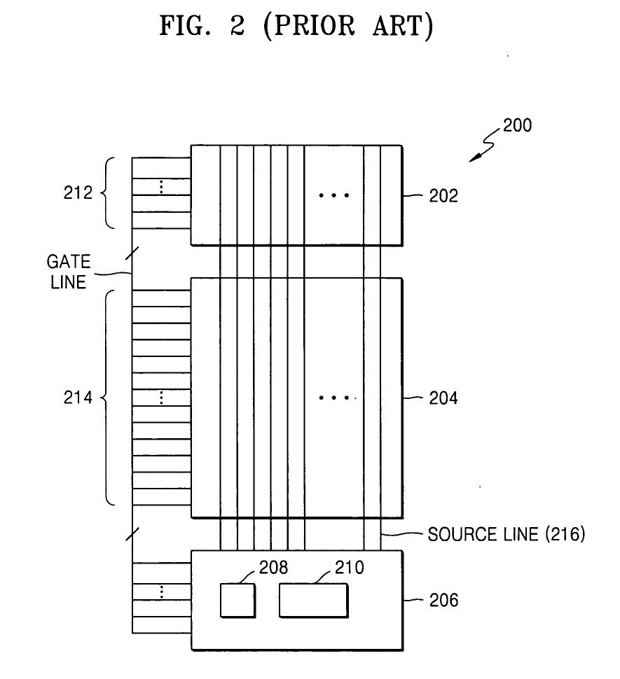

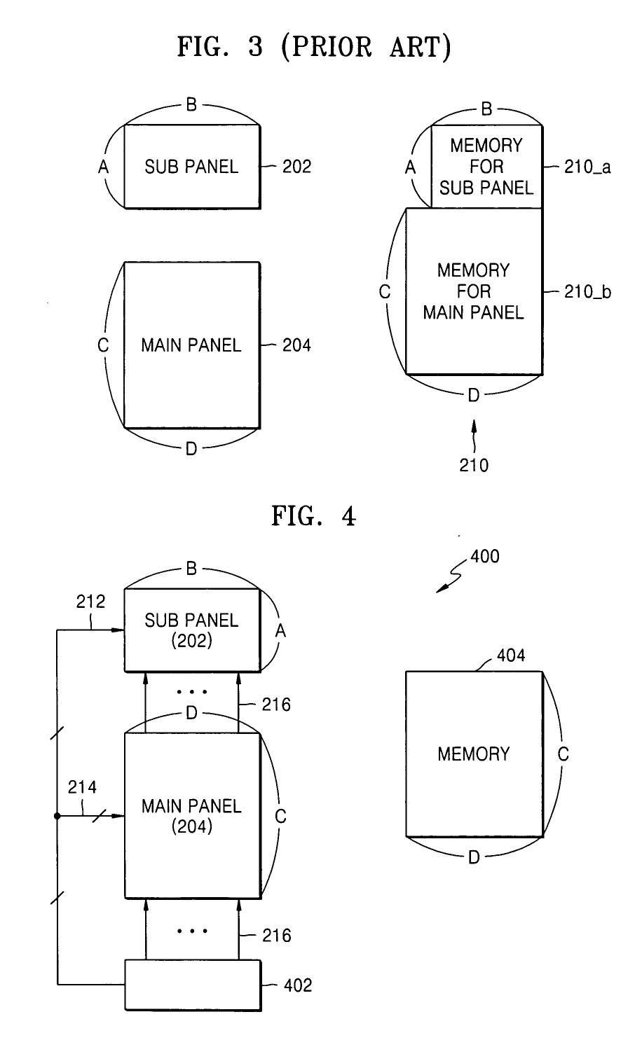

The figures referred to herein are drawn for clarity of illustration and are not necessarily drawn to scale. Elements having the same reference number in FIGS. 1, 2, 3, 4, 5A, 5B, 6, 7, 8, 9, and 10 refer to elements having similar structure and/or function.

### DETAILED DESCRIPTION OF THE INVENTION

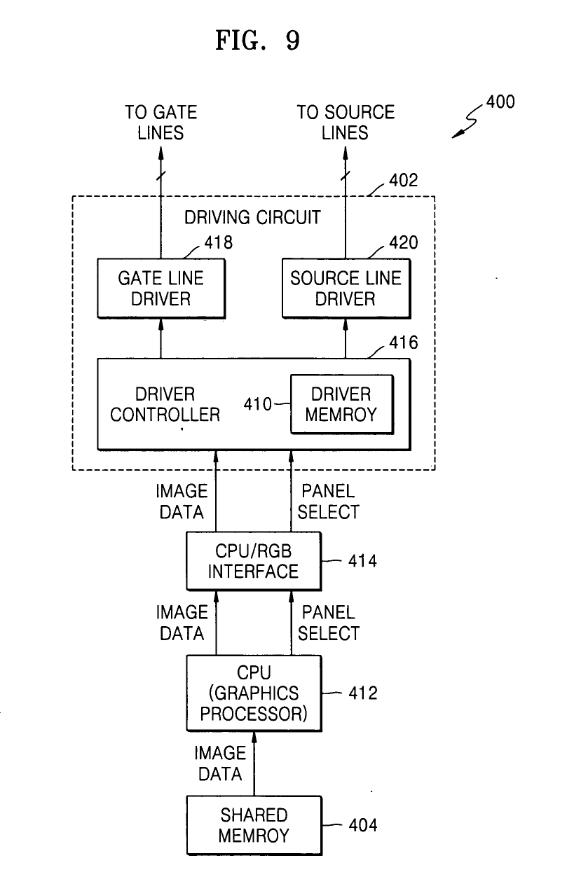

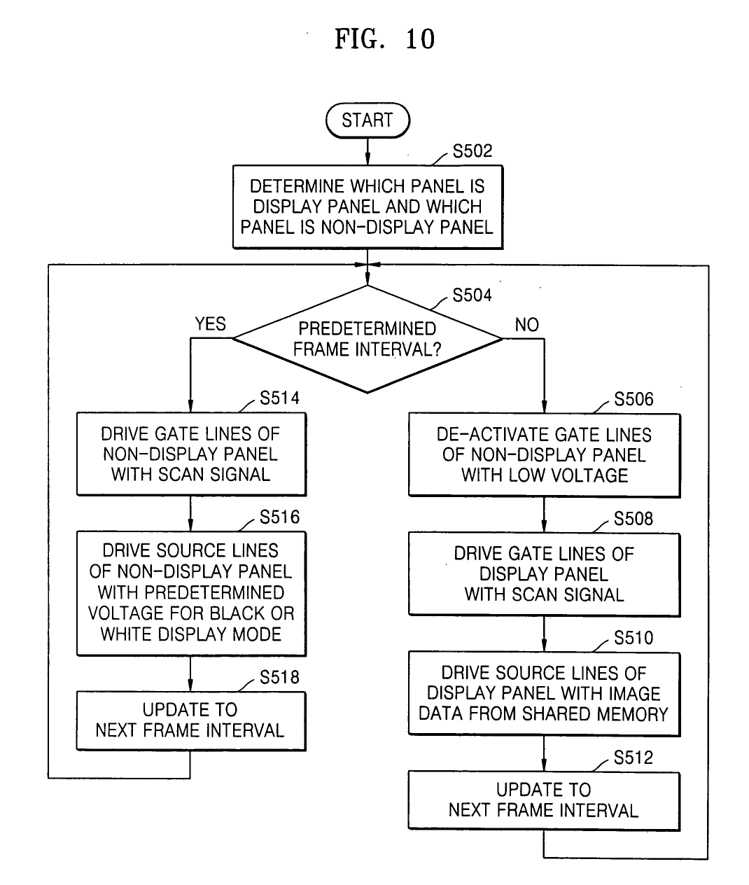

FIG. 4 is a block diagram of a display panel driving system 400 according to an embodiment of the present invention. FIG. 9 is a more detailed block diagram of the display panel driving system 400. FIG. 10 shows a flow-chart of steps during operation of the display panel driving system 400. In one embodiment of the present invention, a driving circuit 402 includes a driver memory 410 that stores sequences of instructions that when executed by a drive controller 416 causes the driver circuit 402 to perform the steps of FIG. 10.

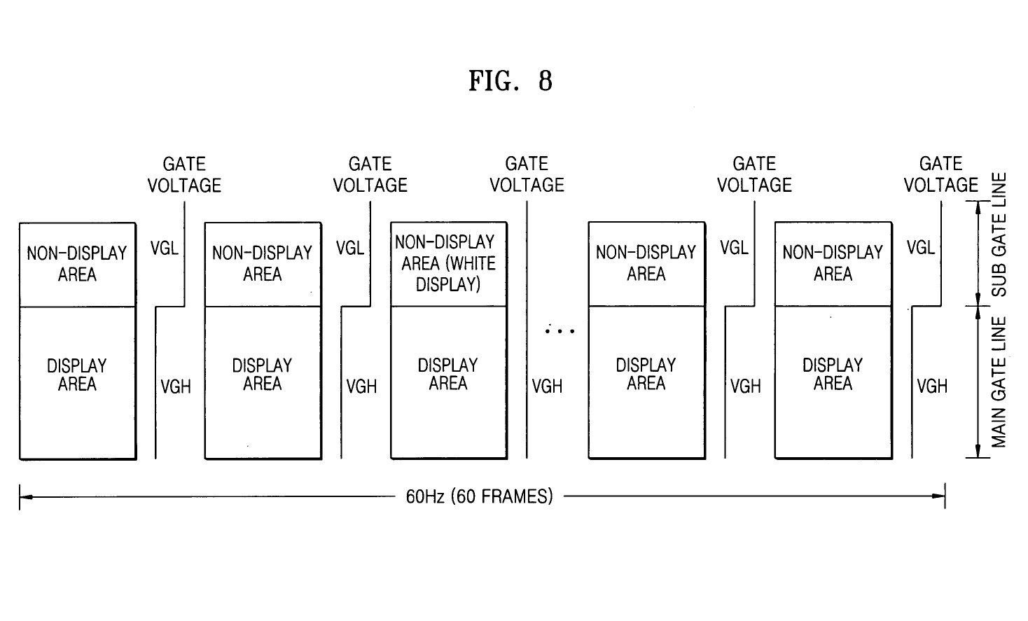

Referring to FIGS. 4 and 8, the dual panel driving system 400 includes a sub display panel 202, a main display panel 204, and a display panel driving circuit 402. The sub display panel 202 has a display area of A×B, where A is the number of gate lines 212 connected to the sub display panel 202 and B is the number of source lines 216 connected to the sub display panel 202. The main display panel 204 has a display area of C×D, where C is the number of gate lines 214 connected to the main display panel 204 and D is the number of source lines 216 connected to the main display panel 204. The display area of the main display panel 204 is larger than that of the sub display panel 202.

The sub display panel 202 is an active matrix panel in which B source lines 206 and A sub gate lines 212 intersect each other, and the main display panel 204 is an active matrix panel in which D source lines 216 and C main gate lines 214 intersect each other. The source lines 216 and the gate lines 212 and 214 are driven by the display panel driving circuit 402. In one example embodiment of the present invention, B source lines 216 of the sub display panel 202 extend as a sub-set from the D source lines 216 of the main display panel 204.

In that case, the number (i.e., B) of the source lines of the sub display panel 202 is equal to or less than the number (i.e., D) of the source lines of the main display panel 204. Additionally, the source lines connected between the two display panels 212 and 214 are formed on a flexible substrate in an example embodiment of the present invention.

In a folder type portable communications terminal, one of the two display panels 202 and 204 is selected as a display mode panel to display image data depending on whether the folder is opened or not opened, or on whether the terminal is used or not used. Accordingly, a shared memory 404 is used for storing image data for both of the display panels 202 and 204. The shared memory 404 has a capacity for displaying image data on either of the sub display panel 202 or the main display panel 204. In general, a size of the sub display panel 202 is smaller than that of the main display panel 204. Thus, the shared memory 404 has a capacity for storing at least the image data corresponding to the C×D size of the main display panel 204.

Referring to FIGS. 9 and 10, a graphics processor 412 sends a panel select signal through a CPU/RGB interface 414 to the driver controller 416. The driver controller 416 determines from the panel select signal which one of the display panels 202 or 204 is a display mode panel and which one of the display panels 202 or 204 is a non-display mode panel (step S502 of FIG. 10).

For example, when a folder of a terminal is closed, only the sub display panel 202 is determined to be the display mode panel that displays image data from the shared memory 404. In that case, the main display panel 204 is determined to be the non-display mode panel. Also in that case, the amount of image data stored in the image memory 404 corresponding to the A×B size of the sub display panel 202 is less than the full capacity of the shared memory 404.

Alternatively, when the folder of the terminal is opened, only the main display panel 204 is determined to be the display mode panel that displays image data from the shared memory 404. In that case, the sub display panel 202 is determined to be the non-display mode panel. Also in that case, the amount of image data stored in the image memory 404 corresponding to the C×D size of the sub display panel 202 is equal to the full capacity of the shared memory 404.

In either case referring to FIG. 4, the image data is transferred from the shared memory 404 by the CPU (graphics processor) 412 and the CPU/RGB interface 414 to the driving circuit 402. Thus, a single shared memory 404 is used for storing image data displayed on either one of the dual display panels 202 and 204 for minimized memory capacity.

The driving circuit 402 drives the gate lines 212 and the B source lines of the sub display panel 202, or drives the gate lines 214 and the D source lines of the main display panel 204, according to the image data from the shared memory 404. The driver controller 416 controls the gate line driver 418 to drive the gate lines 212 and 214 of the panels 202 and 204. The driver controller 416 also controls the source line driver 420 to drive the source lines 216 of the panels 202 and 204.

In some dual folder portable communications terminals, the main display panel 204 and the sub display panel 202 share a single backlight. In that case, when the main display panel 204 is selected as the display mode panel for displaying the image data, the sub display panel 202 is still affected by signals applied on the main display panel 204 by a noise/leakage effect which causes an image to be undesirably displayed on the sub display panel 202 that is determined to be the non-display mode panel.

To prevent such a noise/leakage effect in the sub display panel 202, the dual panel driving system 400 periodically drives the non-display mode panel in a black or white display mode in a partial display operation.

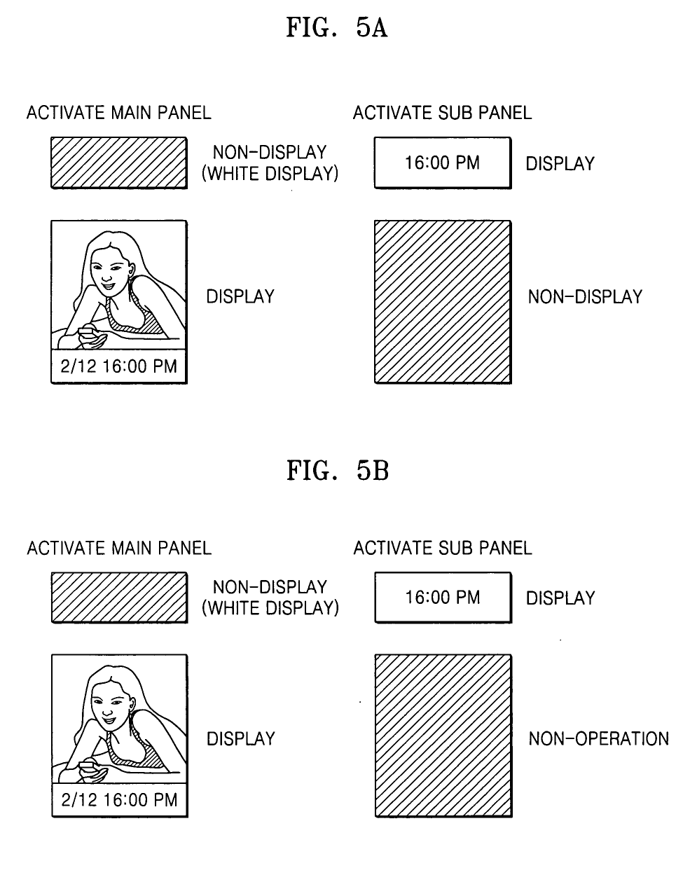

The dual panel driving system and method according to an embodiment of the present invention uses a partial display operation. FIGS. 5A and 5B illustrate such a partial display operation. In FIG. 5A, when the main display panel 204 is the display mode panel, the main display panel displays items such as an image and communication status. In that case, the sub display panel is the non-display mode panel that is provided with predetermined voltages for biasing the source lines for displaying a blank screen. The shared memory 404 stores and outputs the image data displayed on the main display panel 204. The image data determines biasing of the source lines 216 of the main display panel 204.

Alternatively in FIG. 5A, when the sub display panel 202 is the display mode panel, the sub display panel displays items such as time or other data. In that case, the main display panel 204 is the non-display mode panel that is provided with predetermined voltages for biasing the source lines for displaying a blank screen. The shared memory 404 stores and outputs the image data displayed on the sub display panel 202. The image data determines biasing of the source lines of the sub display panel 202.

In either case, the gate line driver 418 of FIG. 9 sequentially provides scan signals to the gate lines 212 of the sub display panel 202 and the gate lines 214 of the main display panel 204. In addition, the source line driver 420 in FIG. 9 drives the source lines 216 for the display mode panel with image data, and drives the source lines 216 for the non-display mode panel with the predetermined voltage for a blank screen.

FIG. 5B illustrates partial display operation when the main display panel 204 is the display mode panel and the non-operation of the main display panel 204 when the sub display panel 202 is the display mode panel. When the main display panel 204 is the display mode panel, the main display panel displays items such as an image and communication status. In that case, the sub display panel is the non-display mode panel that is provided with predetermined voltages for biasing the source lines for displaying a blank screen. The shared memory 404 stores and outputs the image data displayed on the main display panel 204. The image data determines biasing of the source lines 216 of the main display panel 204.

Alternatively in FIG. 5B, when the sub display panel 202 is the display mode panel, the sub display panel 202 displays items such as time or other data with the gate line driver 418 providing scan signals sequentially to the gate lines 212 of the sub display panel 202. In that case, the main display panel 204 is the non-display mode panel, and the gate line driver 418 de-activates the gate lines 214 connected to the main display panel 204. Additionally, when the scan signals are provided to the gate lines 212 of the sub display panel 202, the source lines driver 420 drives the source lines 216 with image data and prepares the next frame.

In FIG. 5B, when the sub display panel 202 is the display mode panel, the main display panel 204 is turned off and only the gate and source lines 212 and 216 of the sub display panel 202 are supplied with power such that only the sub display panel 202 is driven. The shared memory 404 stores and outputs the image data displayed on the sub display panel 202. The image data determines biasing of the source lines of the sub display panel 202.

Alternatively to FIGS. 5A and 5B, the partial display operation may also be performed by defining a certain area of the two display panels as a display area, and defining the remaining area as a non-display area as long as the amount of image data displayed is less than the capacity (C×D) of the shared memory 404.

For reducing the noise/leakage effect in the partial display operation of the present invention, the non-display panel is driven in a black or white display mode depending on the features of the liquid crystal panel and the voltage applied on the source lines 216. For the black display mode, a predetermined low voltage is applied on the source lines 216, and for the white display mode, a predetermined high voltage is applied on the source lines 216. The case of the white display mode is described below for example.

The display mode panel is driven with a display frame rate. For minimizing power consumption, the non-display mode panel is not driven in the white display mode at every frame of the display frame rate. Rather, the non-display mode panel is driven in the white display mode every predetermined frame interval of the display frame rate. Thus, the non-display mode panel is periodically refreshed to the white display mode to compensate for image noise/leakage.

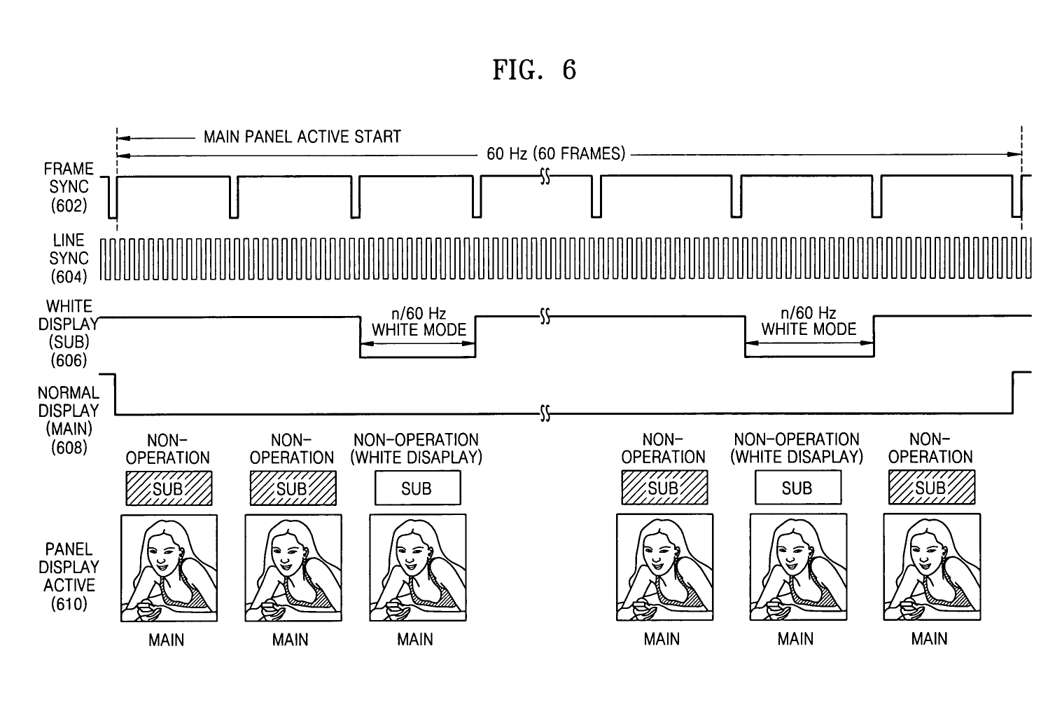

FIG. 6 is a timing diagram of a dual panel driving method according to an embodiment of the present invention. FIG. 6 illustrates the example of the main display panel 204 being set as the display mode panel, and the sub display panel 202 being set as the non-display mode panel. To reduce current consumed by the sub display panel 202, the sub display panel 202 is driven in the white display mode during predetermined frames of the main display panel 204.

In the example of FIG. 6, the main display panel 204 has a display frame rate (i.e., a refresh rate) of (60) Hz. Accordingly, a frame sync signal 602 has a frequency of 60 Hz (i.e., 60 frames per second). A line sync signal 604 is for synchronizing signals transmitted to the gate lines and the source lines of the two display panels 202 and 204. A white display mode signal 606 transmitted to the sub display panel transits to logic “low” for the white display mode at every three frames of the display frame rate. Additionally, a normal display mode signal 608 for the main display panel 204 transits to logic “low” for setting the main display panel 204 to the display mode panel.

Panel display 610 in FIG. 6 shows the display on the sub display panel 202 and the main display panel 204. When the white display signal 606 is logic “high”, the predetermined frame interval is not reached (step S504 of FIG. 10). In that case, the sub display panel 202 is off with the gate lines 212 of the sub display panel 202 being deactivated to a low voltage (i.e. the gate lines 212 being turned off) (step S506 of FIG. 10).

Further in that case, the gate lines 214 of the main display panel 204 are sequentially driven with a scan signal (step S508 of FIG. 10), and the source lines of the main display panel are driven according to the image data from the shared memory 404 (step S510 of FIG. 10). After an image for a frame is displayed on the main display panel 204, the frame sync signal 602 updates to the next frame (step S512 of FIG. 10), and the flow-chart of FIG. 10 returns to step S504.

Alternatively, the display signal 606 is logic “low” every predetermined frame interval which occurs during one frame of every three frames of the frame sync signal 602. The duration of the predetermined frame interval for the white display mode is 33.3 ms (20/60 Hz). Generally, the duration of the white display mode may be set to n/60s, with ‘n’ being dictated by current consumption constraints and visible recognition of the viewer.

During the predetermined frame interval, the gate lines 212 of the sub panel display 202 which is the non-display mode panel are driven with an activated high voltage (step S514 of FIG. 10). For example, the gate lines 212 of the sub display panel 202 are sequentially driven with a scan signal. Additionally during the predetermined frame interval, the source lines of the sub panel display 212 are driven with a predetermined voltage for the white display mode (step S516 of FIG. 10). After the sub display panel 202 is driven to the white display mode, the frame sync signal 602 updates to the next frame (step S518 of FIG. 10), and the flow-chart of FIG. 10 returns to step S504.

FIGS. 6 and 10 illustrate the example case of the main display panel 204 being the display mode panel and the sub display panel 202 being the non-display mode panel. However, the present invention may also be practiced with the main display panel 204 being the non-display mode panel and the sub display panel 202 being the display mode panel as would be apparent to one of ordinary skill in the art from the description herein.

Additionally, the case in which the main display panel is deactivated to be the non-display mode panel is generally when the dual folder of a portable communications terminal is closed. In that case, the gate lines of the main display panel may all be turned off to reduce current consumption.

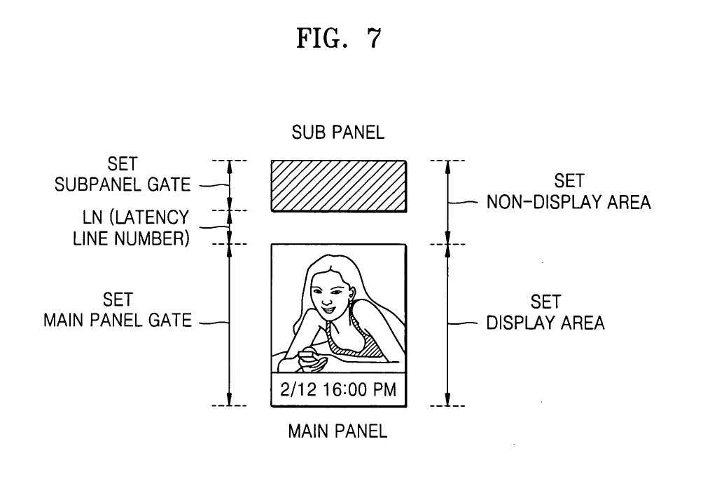

FIG. 7 shows a setting of the gate lines to implement the embodiment illustrated in FIG. 6. Assume that the maximum resolutions of the main display panel and the sub display panel are 176RGB×224 (C×D of FIG. 4) and 176RGB×96 (A×B of FIG. 4), respectively. In that case, the number of gate lines for displaying the dual panels which are recognized as a single screen is 320=number of gate lines of the main display panel+LN bits (the number of latency lines)+number of gate lines of the sub display panel, as illustrated in FIG. 7. Here, the LN bits are used to fix the total number of the gate lines to a predetermined number when the gate lines of the main display panel and the sub display panel are variably set.

Assuming that the dual display panels are recognized as a single screen, while the main display panel operates as the display mode panel, the sub display panel operates as the non-display mode panel that periodically operates in the white display mode. FIG. 8 shows scanning of the gate lines of the main display panel and the sub display panel for such operations of FIG. 6.

Referring to FIG. 8, the gate lines of the main display panel are set to an activated high voltage VGH. Accordingly, image data is displayed on the main display panel when the source lines of the main display are driven with the image data. On the other hand, the gate lines of the sub display panel are periodically set to the activated high voltage VGH every predetermined frame interval and are set to a deactivated low voltage VGL during all other frames.

In FIG. 8, the gate lines connected to the sub display panel are biased with the deactivated low voltage VGL to turn off the sub display panel during the first two frames of the display frame rate of the main display panel. In the third frame, the gate lines of the sub display panel are biased with the activated high voltage VGH such that the sub display panel operates in the white display mode. The predetermined frame intervals for biasing the gate lines of the sub display panel with the activated high voltage VGH may be determined depending on current consumption constraints and the visible recognition of the viewer.

In addition, the source line driver 420 in the driving circuit 402 biases the source lines and the Vcom terminal of the sub panel display that is the non-display mode panel as shown in the following Table 1:

TABLE 1

| Output to source lines of | | Output of the Vcom voltage | |
|---|---|---|---|
| non-display area | | of non-display area | |
| Positive | Negative | Positive | Negative |
| polarity | polarity | polarity | polarity |
| VSS (OV) | VDD (5 V) | VcomL | VcomH |

Such biasing of the source lines and the Vcom terminal for the sub panel display results in a white screen to remove noise on the sub panel display that is the non-display mode panel.

In this manner, a single shared memory 404 is used for storing image data for driving both panels 202 and 204 for minimized memory capacity. In addition, by driving the non-display mode panel in one of the black or white display modes, noise is reduced even when backlight is shared by both panels 202 and 204. Furthermore, the main display panel and the sub display panel are not simultaneously activated to display image data for reducing current consumption.

While the present invention has been particularly shown and described with reference to exemplary embodiments thereof, it will be understood by those of ordinary skill in the art that various changes in form and details may be made therein without departing from the spirit and scope of the present invention as defined by the following claims.

The terms first display panel and second display panel recited in the following claims refer broadly to separate display panels or different portions of a display panel.

1. A method of driving dual display panels, comprising:
determining one of first and second display panels to be a display mode panel and determining the other one of the display panels to be a non-display mode panel;
displaying image data on the display mode panel; and
storing the image data in a same shared memory for when the display mode panel is either one of the first and second display panels.

2. The method of claim 1, wherein the shared memory has a capacity corresponding to a larger one of the first and second display panels.

3. The method of claim 1, further comprising:
driving the non-display mode panel in a selected one of a black display mode or a white display mode.

4. The method of claim 3, further comprising:
driving gate lines of the non-display mode panel with an activated voltage every predetermined frame interval for a display frame rate for the display mode panel.

5. The method of claim 4, further comprising:
driving source lines of the non-display mode panel with a respective predetermined voltage corresponding to the selected one of the black display mode or the white display mode when the gate lines of the non-display mode panel are driven with the activated voltage.

6. The method of claim 1, wherein the display mode panel is set to the larger one of the first and second display panels.

7. The method of claim 6, wherein source lines of the non-display mode panel are extended from a subset of source lines of the display mode panel.

8. A method of driving dual display panels, comprising:
determining one of first and second display panels to be a display mode panel and determining the other one of the display panels to be a non-display mode panel;
displaying image data on the display mode panel at a display frame rate; and
driving the non-display mode panel in a selected one of a black display mode or a white display mode every predetermined frame interval of the display frame rate.

9. The method of claim 8, wherein the display mode panel is set to the larger one of the first and second display panels.

10. The method of claim 8, further comprising:
driving gate lines of the non-display mode panel with an activated voltage for the every predetermined frame interval; and
driving source lines of the non-display mode panel with a respective predetermined voltage corresponding to the selected one of the black display mode or the white display mode when the gate lines of the non-display mode panel are driven with the activated voltage.

11. A dual display driving system, comprising:
a first display panel;
a second display panel;
a graphics processor that sets one of first and second display panels to be a display mode panel and that sets the other one of the display panels to be a non-display mode panel;
a driving circuit for driving gate lines and source lines of the display mode panel to display image data; and
a shared memory that stores the image data for when the display mode panel is either one of the first and second display panels.

12. The dual display driving system of claim 11, wherein the shared memory has a capacity corresponding to a larger one of the first and second display panels.

13. The dual display driving system of claim 11, wherein the driving circuit drives the non-display mode panel in a selected one of a black display mode or a white display mode.

14. The dual display driving system of claim 13, wherein the driving circuit drives gate lines of the non-display mode panel with an activated voltage every predetermined frame interval for a display frame rate for the display mode panel.

15. The dual display driving system of claim 14, wherein the driving circuit drives source lines of the non-display mode panel with a respective predetermined voltage corresponding to the selected one of the black display mode or the white display mode when the gate lines of the non-display mode panel are driven with the activated voltage.

16. The dual display driving system of claim 11, wherein the display mode panel is set to the larger one of the first and second display panels.

17. The dual display driving system of claim 16, wherein source lines of the non-display mode panel are extended from a subset of source lines of the display mode panel.

18. A dual display driving system, comprising:
a first display panel;
a second display panel;
a graphics processor that sets one of first and second display panels to be a display mode panel and that sets the other one of the display panels to be a non-display mode panel; and
a driving circuit for driving gate lines and source lines of the display mode panel to display image data at a display frame rate, and for driving the non-display mode panel in a selected one of a black display mode or a white display mode every predetermined frame interval of the display frame rate.

19. The dual display driving system of claim 18, wherein the display mode panel is set to the larger one of the first and second display panels.

20. The dual display driving system of claim 18, wherein the driving circuit drives gate lines of the non-display mode panel with an activated voltage for the every predetermined frame interval, and wherein the driving circuit drives source lines of the non-display mode panel with a respective predetermined voltage corresponding to the selected one of the black display mode or the white display mode when the gate lines of the non-display mode panel are driven with the activated voltage.
